(19) United States
(12) Patent Application Publication
(10) Pub. No.: US 2023/0134636 A1
(43) Pub. Date: May 4, 2023

(54) HERMETICALLY SEALED ELECTROMAGNETIC CONTACTOR

(71) Applicant: FUJI ELECTRIC FA COMPONENTS & SYSTEMS CO., LTD., Konosu-shi (JP)

(72) Inventors: Takashi TSUTSUMI, Kounosu-city (JP); Koujun KONISHI, Kounosu-city (JP); Hideo ADACHI, Fukaya-city (JP)

(73) Assignee: FUJI ELECTRIC FA COMPONENTS & SYSTEMS CO., LTD., Konosu-shi (JP)

(21) Appl. No.: 18/091,013

(22) Filed: Dec. 29, 2022

Related U.S. Application Data
(63) Continuation of application No. PCT/JP2021/044681, filed on Dec. 6, 2021.

(30) Foreign Application Priority Data
Jan. 22, 2021 (JP) 2021-008375

(51) Int. Cl. H01H 1/66; H01H 50/02; H01H 50/56; H01H 50/44

(52) U.S. Cl. CPC H01H 1/66; H01H 50/023; H01H 50/56; H01H 50/443; H01H 2050/446

(57) ABSTRACT

A hermetically sealed electromagnetic contactor including: a main contact unit including a pair of main fixed contact pieces, each of the main fixed contact pieces having a main fixed contact at one end and a terminal portion to be connected to a main circuit at the other end, and a main movable contact piece having a pair of main movable contacts configured to come into contact with and be separated from the main fixed contacts and configured to open and close an electrical path of the main circuit; a contact support configured to support the main movable contact piece; an electromagnet unit configured to switch opening/closing of the main contact unit via the contact support; and a hermetically sealed container made of resin on an inside of which the main contact unit and the electromagnet unit are arranged, the hermetically sealed container having the inside filled with insulating gas.

### CROSS-REFERENCE TO RELATED APPLICATION

This application is a continuation application filed under 35 U.S.C. § 111(a) of International Patent Application No. PCT/JP2021/044681, filed on Dec. 6, 2021, the contents of which are incorporated herein by reference.

### TECHNICAL FIELD

The present invention relates to a hermetically sealed electromagnetic contactor.

### BACKGROUND ART

In a hermetically sealed electromagnetic contactor described in JP 2018-163761 A, by housing a contact unit in a hermetically sealed container, which is made of metal and is covered by a lid made of ceramic, and filling the hermetically sealed container with pressurized insulating gas, such as hydrogen, breaking performance of the contact is improved without causing an arc-extinguishing space to become larger in size.

### SUMMARY OF INVENTION

### Technical Problem

There has been a limit to miniaturization and weight reduction and a degree of freedom in design for a configuration in which a hermetically sealed container made of metal and covered by a lid made of ceramic is used.

An object of the present invention is to, in a hermetically sealed electromagnetic contactor, not only achieve miniaturization and weight reduction but also improve a degree of freedom in design.

### Solution to Problem

According to an aspect of the present invention, there is provided a hermetically sealed electromagnetic contactor including: a main contact unit including a pair of main fixed contact pieces, each of the main fixed contact pieces having a main fixed contact at one end and a terminal portion to be connected to a main circuit at the other end, and a main movable contact piece having a pair of main movable contacts configured to come into contact with and be separated from the main fixed contacts and configured to open and close an electrical path of the main circuit; a contact support configured to support the main movable contact piece; an electromagnet unit configured to switch opening/closing of the main contact unit via the contact support; and a hermetically sealed container made of resin on an inside of which the main contact unit and the electromagnet unit are arranged, the hermetically sealed container having the inside filled with insulating gas.

### Advantageous Effects of Invention

According to the present invention, by using a hermetically sealed container made of resin, it is possible to not only achieve miniaturization and weight reduction but also improve a degree of freedom in design.

### BRIEF DESCRIPTION OF DRAWINGS

FIG. 1 is an external view of a hermetically sealed electromagnetic contactor (single pole);

FIG. 2 is an external view of a hermetically sealed container (single pole);

FIG. 3 is an exploded view of the hermetically sealed container (single pole);

FIG. 4 is a cross-sectional view of the hermetically sealed container (single pole);

FIG. 5 is another cross-sectional view of the hermetically sealed container (single pole);

FIG. 6 is a cross-sectional view of a coil contact piece;

FIG. 7 is a diagram illustrative of the coil contact pieces, support springs, and relay contact pieces;

FIG. 8 is a cross-sectional view of an auxiliary contact unit;

FIGS. 9A and 9B are diagrams illustrative of a nut member;

FIG. 10 is an external view of a hermetically sealed electromagnetic contactor (double poles);

FIG. 11 is an external view of a hermetically sealed container (double poles);

FIG. 12 is an exploded view of the hermetically sealed container (double poles);

FIG. 13 is a diagram illustrative of a partition wall member, a contact support, and an electromagnet unit after assembly; and

FIG. 14 is a cross-sectional view of the hermetically sealed container (double poles).

### DESCRIPTION OF EMBODIMENTS

Hereinafter, embodiments of the present invention are described with reference to the drawings. It should be noted that each drawing is schematic and may not be the same as actual one. Additionally, the embodiments given below exemplify devices and methods for embodying the technological concept of the present invention, and do not limit components of the invention to those below. In other words, various modifications can be added to the technological concept of the present invention without departing from the technological scope described in the appended claims.

### FIRST EMBODIMENT

### Configuration

In the following description, for descriptive purposes, three directions orthogonal to one another are assumed to be the vertical direction, the width direction, and the depth direction.

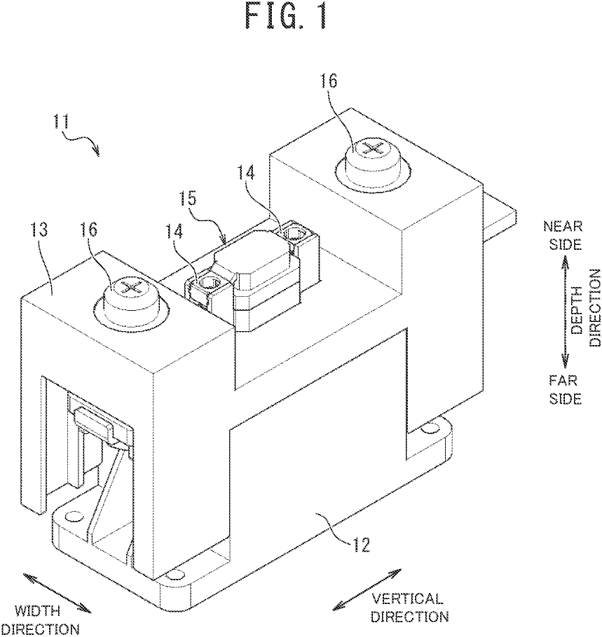

FIG. 1 is an external view of a hermetically sealed electromagnetic contactor (single pole).

A hermetically sealed electromagnetic contactor 11 is of a single pole type and opens and closes an electrical path of a main circuit, and includes an auxiliary contact that opens and closes an electrical path of an auxiliary circuit in an interlocking manner with opening and closing of the main circuit. The hermetically sealed electromagnetic contactor 11 includes a case 12, a main terminal cover 13, an auxiliary terminal cover 14, and a hermetically sealed container 15.

The case 12 is made of a resin having electrical insulation and is mounted via mounting holes, which are formed at four corners on the far side in the depth direction.

The main terminal cover 13 is made of a resin having electrical insulation and, by being attached to the near side in the depth direction of the case 12 and preventing exposure of main terminals, improves safety at the time of maintenance and inspection performed by a worker. The main terminal cover 13 is formed by integrating a primary side portion and a secondary side portion, and both the primary side portion and the secondary side portion are fixed by fitting resin nuts 16 to ends of through bolts, which are fastened to main terminals. Each of the resin nuts 16 is made of a resin having electrical insulation, has the near side in the depth direction closed in a bag shape, and has a cross groove formed on a head.

The auxiliary terminal cover 14 is made of a resin having electrical insulation and, by preventing exposure of auxiliary terminals, improves safety at the time of maintenance and inspection performed by a worker. The auxiliary terminal cover 14 includes a primary side portion and a secondary side portion that are formed in separate bodies, and is fixed by being fitted to the hermetically sealed container 15.

The hermetically sealed container 15 is made of a resin having electrical insulation and is housed in and fixed to the case 12.

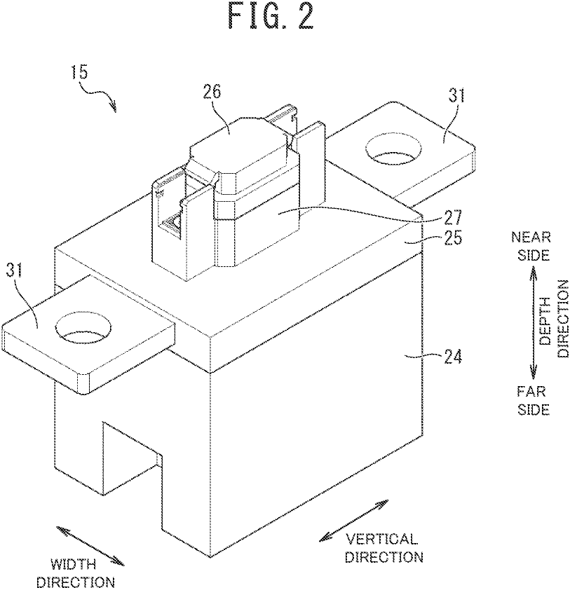

FIG. 2 is an external view of a hermetically sealed container (single pole).

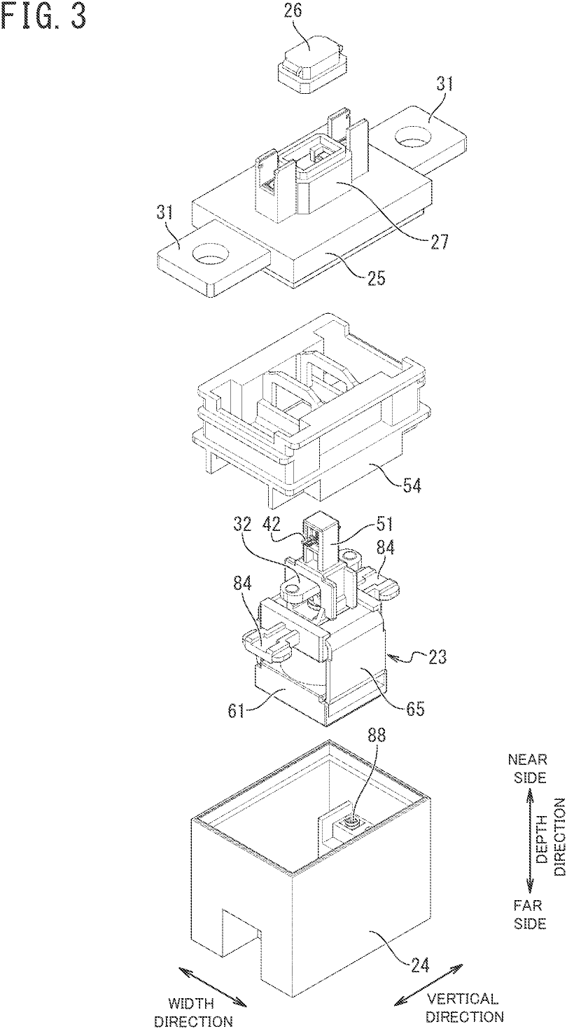

FIG. 3 is an exploded view of the hermetically sealed container (single pole).

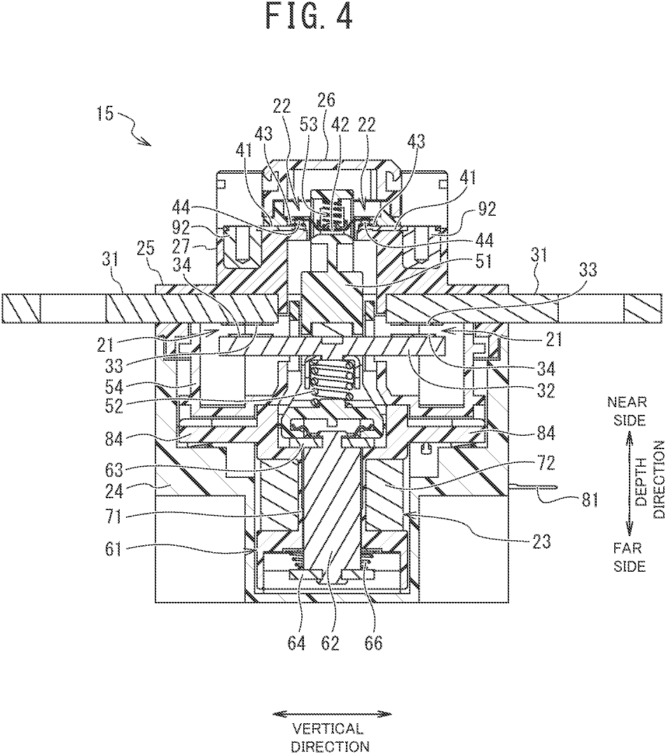

FIG. 4 is a cross-sectional view of the hermetically sealed container (single pole).

In this drawing, a cross section passing the center in the width direction and taken along the vertical direction and the depth direction is illustrated.

The hermetically sealed container 15 houses a main contact unit 21, an auxiliary contact unit 22, and an electromagnet unit 23 and is further filled with pressurized insulating gas, such as hydrogen and nitrogen. The hermetically sealed container 15 not only has a container portion 24, a lid portion 25, and a cap portion 26 fixed to each other with epoxy resin-based adhesive, but also has gas barrier coating applied to the entire outer peripheral surface including boundary portions, using laminated films of clay crystals. Specifically, exchanging interlayer ions in purified smectite and joining the laminated films with an organic binder, such as polyvinyl alcohol (PVA) and water-soluble nylon, causes the laminated films to exhibit labyrinth effect and thereby prevent permeation of gas molecules, such as hydrogen and nitrogen. The laminated films are stacked in the thickness direction, and the thickness thereof is, for example, 2 µm. The gas barrier coating is applied by a spray method in which coating liquid is formed into mist and applied to the hermetically sealed container 15, and is completed by being burned at a temperature at which interlayer ions are incorporated into clay crystals, for example, a temperature greater than or equal to 150° C. Since, as described above, gas barrier coating is applied to the entire outer peripheral surface, the outer peripheral shape of the hermetically sealed container 15 is preferably formed in a polygon that is composed of planes that are flat and linear to the extent possible.

The container portion 24 is formed in a square box shape that has the far side in the depth direction, both sides in the vertical direction, and both sides in the width direction closed and the near side in the depth direction opened.

The lid portion 25 fits into the open end of the container portion 24 and closes the near side in the depth direction of the container portion 24. The lid portion 25 is formed in a substantially hat-shape by a small cylinder portion 27, which protrudes toward the near side in the depth direction, being formed at the center of the lid portion 25. The small cylinder portion 27 is formed in a square cylinder shape that has the far side in the depth direction communicating with the inside of the container portion 24 and the near side in the depth direction opened.

The cap portion 26 fits into the open end of the small cylinder portion 27 and closes the near side in the depth direction of the small cylinder portion 27.

The main contact unit 21 is a contact unit connected to a main circuit via the through bolts and configured to open and close an electrical path of the main circuit, and the hermetically sealed container 15 includes a pair of main fixed contact pieces 31 and a main movable contact piece 32.

The pair of main fixed contact pieces 31 are made of a metal having conductivity, are long flat plates extending in the vertical direction and aligned with the vertical direction and the width direction, and are arranged in series with a gap interposed therebetween in the vertical direction inside the hermetically sealed container 15. That is, the pair of main fixed contact pieces 31 extend along a surface orthogonal to a direction in which the main contact unit 21 is opened and closed. On one end sides of the pair of main fixed contact pieces 31, which are the sides facing each other, main fixed contacts 33 are respectively brazed on surfaces on the far side in the depth direction. On the other end sides of the pair of main fixed contact pieces 31, which are the sides turning away from each other, main terminal portions are formed outside the hermetically sealed container 15, and one and the other of the main terminal portions are connected to the primary side and the secondary side of the main circuit, respectively.

The pair of main fixed contact pieces 31 are integrated with the lid portion 25 in such a manner as to penetrate through sidewalls of the lid portion 25 by insert molding. Specifically, after fine micron-sized protruding and recessed shapes are formed on the surfaces of the main fixed contact pieces 31 by chemical etching, insert molding is performed. Through this processing, melted resin enters the inside of the protruding and recessed shapes and solidification of the resin causes the metal and the resin to be joined at the interface level and produces complex junctions exhibiting labyrinth effect, which prevents gas molecules, such as hydrogen and nitrogen, from leaking. Examples of the metal surface treatment technology include “AMALPHA” (registered trademark) by MEC COMPANY LTD.

The main movable contact piece 32 is made of a metal having conductivity, is a long flat plate extending in the vertical direction and aligned with the vertical direction and the width direction, and is arranged on the far side in the depth direction of the pair of main fixed contact pieces 31. On both end sides of the main movable contact piece 32, main movable contacts 34 are brazed on a surface on the near side in the depth direction. The main movable contact piece 32 causes the main movable contacts 34 to be respectively separated from the main fixed contacts 33 when the main movable contact piece 32 retreats to the far side in the depth direction, and causes the main movable contacts 34 to respectively come into contact with the main fixed contacts 33 when the main movable contact piece 32 advances to the near side in the depth direction. The main contact unit 21 is formed by the main fixed contacts 33 and the main movable contacts 34.

The auxiliary contact unit 22 is a contact unit connected to an auxiliary circuit via terminal screws and configured to open and close an electrical path of the auxiliary circuit, and the hermetically sealed container 15 includes a pair of auxiliary fixed contact pieces 41 and an auxiliary movable contact piece 42.

The pair of auxiliary fixed contact pieces 41 are made of a metal having conductivity, are long flat plates extending in the vertical direction and aligned with the vertical direction and the width direction, and are arranged in series with a gap interposed therebetween in the vertical direction inside the hermetically sealed container 15. On one end sides of the pair of auxiliary fixed contact pieces 41, which are the sides facing each other, auxiliary fixed contacts 43 are respectively brazed on surfaces on the near side in the depth direction. On the other end sides of the pair of auxiliary fixed contact pieces 41, which are the sides turning away from each other, auxiliary terminal portions are formed outside the hermetically sealed container 15, and one and the other of the auxiliary terminal portions are connected to the primary side and the secondary side of the auxiliary circuit, respectively. The pair of auxiliary fixed contact pieces 41 are integrated with the small cylinder portion 27 in such a manner as to penetrate through sidewalls of the small cylinder portion 27 by insert molding. As for a method of insert molding, the same method as that used for the afore-described main fixed contact pieces 31 can be used.

The auxiliary movable contact piece 42 is made of a metal having conductivity, is formed in a plate shape extending in the vertical direction and aligned with the vertical direction and the width direction, and is arranged on the near side in the depth direction of the pair of auxiliary fixed contact pieces 41. That is, when viewed from the depth direction, the long-length directions of the main movable contact piece 41 and the auxiliary movable contact piece 42 are the same as each other. Both end sides of the auxiliary movable contact piece 42 bifurcate and form dual contacts, and auxiliary movable contacts 44 are brazed on a surface on the far side in the depth direction of the auxiliary movable contact piece 42. The auxiliary movable contact piece 42 causes the auxiliary movable contacts 44 to respectively come into contact with the auxiliary fixed contacts 43 when the auxiliary movable contact piece 42 retreats to the far side in the depth direction, and causes the auxiliary movable contacts 44 to be respectively separated from the auxiliary fixed contacts 43 when the auxiliary movable contact piece 42 advances to the near side in the depth direction. The auxiliary contact unit 22 is formed by the auxiliary fixed contacts 43 and the auxiliary movable contacts 44.

The main movable contact piece 32 and the auxiliary movable contact piece 42 are supported by a contact support 51. The contact support 51 is made of a resin having electrical insulation, is formed in a substantially inverted-T shape when viewed from the vertical direction, and is arranged between the pair of main fixed contact pieces 31. The contact support 51 elastically supports the main movable contact piece 32 via a main contact spring 52 on the far side in the depth direction of the main fixed contact pieces 31. The main contact spring 52 maintains contact pressure of the main contact unit 21 constant by biasing the main movable contact piece 32 to the near side in the depth direction. The contact support 51 elastically supports the auxiliary movable contact piece 42 via an auxiliary contact spring 53 on the near side in the depth direction of the auxiliary fixed contact pieces 41. The auxiliary contact spring 53 maintains contact pressure of the auxiliary contact unit 22 constant by biasing the auxiliary movable contact piece 42 to the far side in the depth direction. The contact support 51 is held by a partition wall member 54 (see FIG. 3). The partition wall member 54 is made of a resin having electrical insulation and is housed on the near side in the depth direction in the container portion 24.

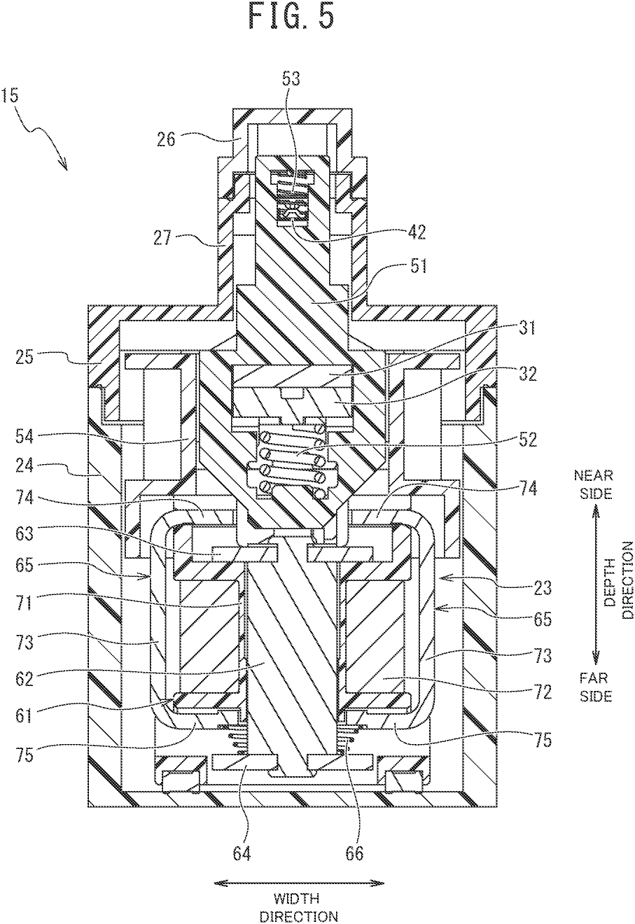

FIG. 5 is another cross-sectional view of the hermetically sealed container (single pole).

In this drawing, a cross section passing the center in the vertical direction and taken along the width direction and the depth direction is illustrated.

The electromagnet unit 23 is housed on the far side in the depth direction in the container portion 24 and switches opening/closing of the main contact unit 21 and opening/closing of the auxiliary contact unit 22. The electromagnet unit 23 includes a spool 61, a plunger 62, an upper armature 63, a lower armature 64, yokes 65, and a return spring 66.

The spool 61 is made of a resin having electrical insulation, and a coil 72 is wound around a cylindrical winding shaft 71, which extends in the depth direction.

The plunger 62 is a columnar movable iron core, which extends in the depth direction, and is inserted into the winding shaft 71. The plunger 62 has the near side in the depth direction coupled to the contact support 51 via a plate spring.

The upper armature 63 is a flat plate-shaped yoke aligned with the vertical direction and the width direction and is fixed to the near side in the depth direction of the plunger 62.

The lower armature 64 is a flat plate-shaped yoke aligned with the vertical direction and the width direction and is fixed to the far side in the depth direction of the plunger 62.

The pair of yokes 65 are plate-shaped yokes, and each of the yokes 65 is fixed to one of one side and the other side in the width direction of the spool 61. Each of the yokes 65 includes a side piece portion 73, an upper piece portion 74, and a lower piece portion 75 and is formed in a substantially U-shape opening to the inner side in the width direction when viewed from the vertical direction.

The side piece portion 73 is formed in a plate shape aligned with the vertical direction and the depth direction and covers the outer side in the width direction of the spool 61.

The upper piece portion 74 is formed in a plate shape aligned with the vertical direction and the width direction and projects from the near side in the depth direction of the side piece portion 73 toward the inner side in the width direction.

The lower piece portion 75 is formed in a plate shape aligned with the vertical direction and the width direction and projects from the far side in the depth direction of the side piece portion 73 toward the inner side in the width direction.

Separation distance between the upper piece portion 74 and the lower piece portion 75 is the same as separation distance between the upper armature 63 and the lower armature 64. The upper piece portion 74 is disposed on the near side in the depth direction of the upper armature 63, and the lower piece portion 75 is disposed on the near side in the depth direction of the lower armature 64.

The return spring 66 is inserted onto the plunger 62 while being sandwiched between the lower armature 64 and the lower piece portions 75 and biases the plunger 62 to the far side in the depth direction with respect to the spool 61.

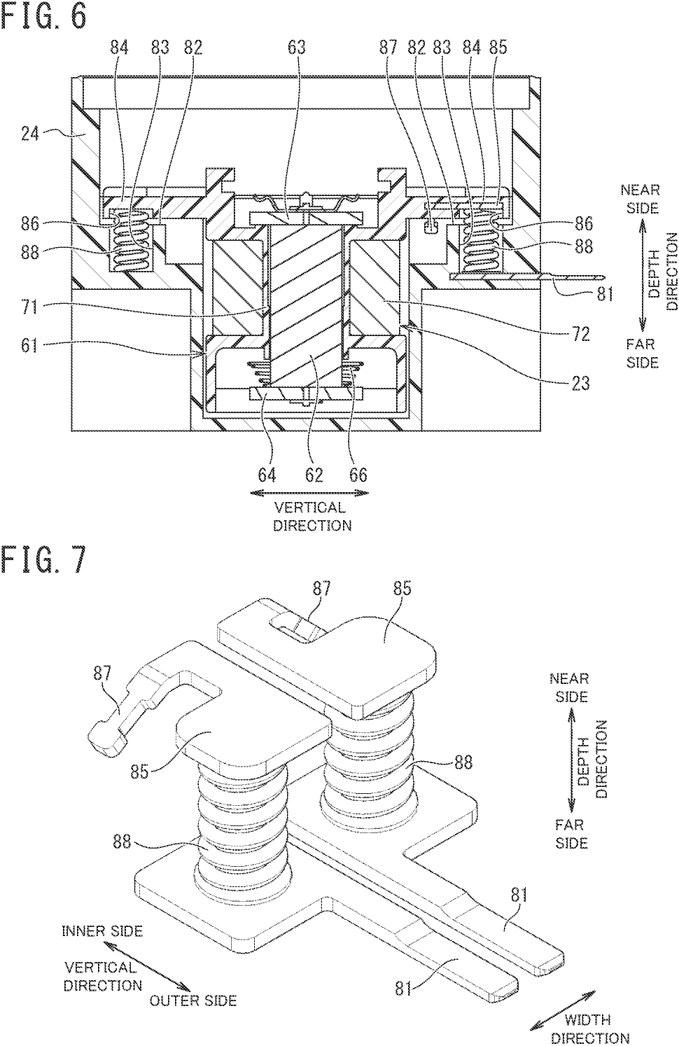

FIG. 6 is a cross-sectional view of a coil contact piece.

In this drawing, a cross section passing a coil contact piece 81 and taken along the vertical direction and the depth direction is illustrated.

A pair of coil contact pieces 81 are made of a metal having conductivity, are formed in plate shapes aligned with the vertical direction and the width direction, and are arranged in parallel with a gap interposed therebetween in the width direction (see FIG. 7). One of the coil contact pieces 81 has the inner side in the vertical direction arranged inside the hermetically sealed container 15 and the outer side in the vertical direction connected to the positive side of a control circuit outside the hermetically sealed container 15.

The other of the coil contact pieces 81 has the inner side in the vertical direction arranged inside the hermetically sealed container 15 and the outer side in the vertical direction connected to the negative side of the control circuit outside the hermetically sealed container 15. The pair of coil contact pieces 81 are integrated with the container portion 24 in such a manner as to penetrate through a sidewall of container portion 24 by insert molding. As for a method of insert molding, the same method as that used for the afore-described main fixed contact pieces 31 can be used.

On the inner peripheral surface of the container portion 24, a step-shaped spool receiving portion 82 is formed on each of both end sides in the vertical direction. On each of the spool receiving portions 82, two deep recessed portions 83, each of which is recessed toward the far side in the depth direction, are formed on a surface on the near side in the depth direction. A pair of deep recessed portions 83 are arranged in parallel with a gap interposed therebetween in the width direction, and, on one side in the vertical direction, the inner sides in the vertical direction of the coil contact pieces 81 are exposed by the deep recessed portions 83. The front surfaces of the coil contact pieces 81 that are exposed on one side in the vertical direction and the bottom surfaces of the deep recessed portions 83 formed on the other side in the vertical direction are located at the same position in the depth direction.

On the spool 61, an arm piece 84, which projects toward the outer side in the vertical direction, is formed on the near side in the depth direction and each of both sides in the vertical direction (see FIG. 3). Each of the arm pieces 84 is formed in a substantially plate shape aligned with the vertical direction and the vertical direction and serves as a cantilever. On one side in the vertical direction, a pair of relay contact pieces 85 are insert-molded in the arm piece 84 (see FIG. 7). The pair of relay contact pieces 85 are made of a metal having conductivity and are formed in plate shapes aligned with the vertical direction and the width direction. Since the relay contact pieces 85 are not components that penetrate through the hermetically sealed container 15, the method of insert molding does not require a special metal surface treatment technology as in a case of the afore-described main fixed contact pieces 31.

On each of the arm pieces 84, two shallow recessed portions 86, each of which is recessed toward the near side in the depth direction, are formed on a surface on the far side in the depth direction. Each pair of shallow recessed portions 86 are arranged in parallel with a gap interposed therebetween in the width direction, and, on one side in the vertical direction, the outer sides in the vertical direction of the relay contact pieces 85 are exposed by the shallow recessed portions 86. The front surfaces of the relay contact pieces 85 that are exposed on one side in the vertical direction and the bottom surfaces of the shallow recessed portions 86 formed on the other side in the vertical direction are located at the same position in the depth direction. On each of the relay contact pieces 85, a projecting portion 87, which projects from an end portion on the inner side in the vertical direction toward the outer side in the width direction, is formed (see FIG. 7). Each of the projecting portions 87 projects from a side surface in the width direction of the arm piece 84 and is inclined to the far side in the depth direction. To one of the projecting portions 87, one end of a winding wire of the coil 72 is soldered, and, to the other of the projecting portions 87, the other end of the winding wire of the coil 72 is soldered.

In each of the deep recessed portions 83 and corresponding one of the shallow recessed portions 86, a support spring 88 (spring member) is housed. Each of the support springs 88 has a feature that free height when no load is applied in the compression direction is greater than a dimension obtained by adding depth of a shallow recessed portion 86 to depth of a deep recessed portion 83. Although, when all the components are housed in the hermetically sealed container 15, a load in the compression direction is applied to the support springs 88, the support springs 88 are set to keep the arm pieces 84 separated upward from the spool receiving portions 82 even on this occasion (see FIG. 4). Therefore, the spool 61 has the pair of arm pieces 84 suspended on two pairs of support springs 88, each pair of which is disposed on one side. When the lid portion 25 is fixed to the container portion 24, the spool 61 being pressed to the pair of main fixed contact pieces 31 via the partition wall member 54 due to repulsive force of the support springs 88 causes backlash to be suppressed.

FIG. 7 is a diagram illustrative of the coil contact pieces, the support springs, and the relay contact pieces.

In this drawing, a configuration in which only the coil contact pieces 81, the relay contact pieces 85, and the support springs 88 are picked out and the container portion 24, the arm pieces 84, the spool receiving portions 82, and the like are omitted is illustrated. The support springs 88 are made of a metal having conductivity. On one side in the vertical direction, the support springs 88 are sandwiched between the coil contact pieces 81 and the relay contact pieces 85 while being compressed, and the support springs 88 are in contact with both the coil contact pieces 81 and the relay contact pieces 85. This configuration causes the coil contact pieces 81 and the coil 72 to be electrically connected. Therefore, on the one side in the vertical direction, the support springs 88 serve as both a support of the spool 61 and an electrical connection for the coil contact pieces 81.

According to the above description, when the coil 72 is in a non-excited state in which no current is applied to the coil 72, the plunger 62 has retreated to the far side in the depth direction due to repulsive force of the return spring 66 and, in association therewith, the contact support 51 also retreats to the far side in the depth direction. Because of this configuration, the main contact unit 21 is opened and, at the same time, the auxiliary contact unit 22 is closed. On this occasion, the upper armature 63 is separated from the upper piece portions 74, and the lower armature 64 is separated from the lower piece portions 75.

When, while the coil 72 is in this state, current is applied to the coil 72 and the coil 72 is excited, the upper armature 63 is attracted and stuck to the upper piece portions 74 and, at the same time, the lower armature 64 is attracted and stuck to the lower piece portions 75. Therefore, the plunger 62 advances to the near side in the depth direction against the repulsive force of the return spring 66 and, in association therewith, the contact support 51 also advances to the near side in the depth direction. Because of this configuration, the main contact unit 21 is closed and, at the same time, the auxiliary contact unit 22 is opened.

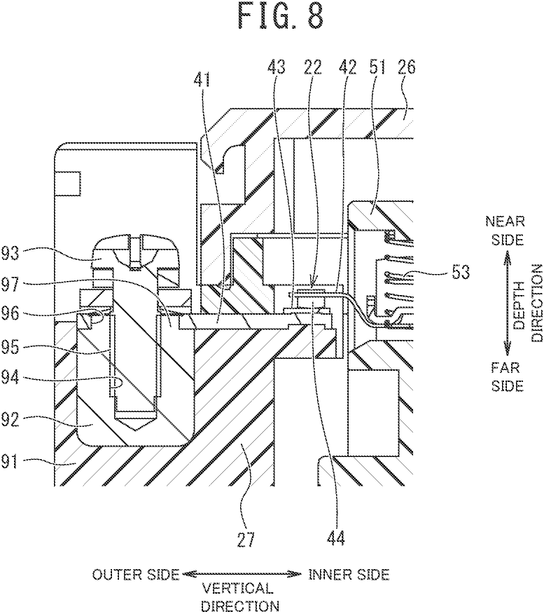

FIG. 8 is a cross-sectional view of the auxiliary contact unit.

In this drawing, a cross section passing the center in the width direction and taken along the vertical direction and the depth direction is illustrated.

On the small cylinder portion 27, terminal receiving portions 91 are formed on the back surface side, that is, on the far side in the depth direction, of the auxiliary fixed contact pieces 41, which are located on the outer sides in the vertical direction of the small cylinder portion 27. Each of the terminal receiving portions 91 is a portion projecting from a sidewall of the small cylinder portion 27 toward the outer side in the vertical direction, and a nut member 92 is integrated with the terminal receiving portion 91 by insert molding. Each of the nut members 92 is made of a metal having conductivity and is formed in a cylindrical shape, and, on the near side in the depth direction, a bottomed threaded hole 94, into which a terminal screw 93 is fitted, is formed in the depth direction. As for a method of insert molding, the same method as that used for the afore-described main fixed contact pieces 31 can be used.

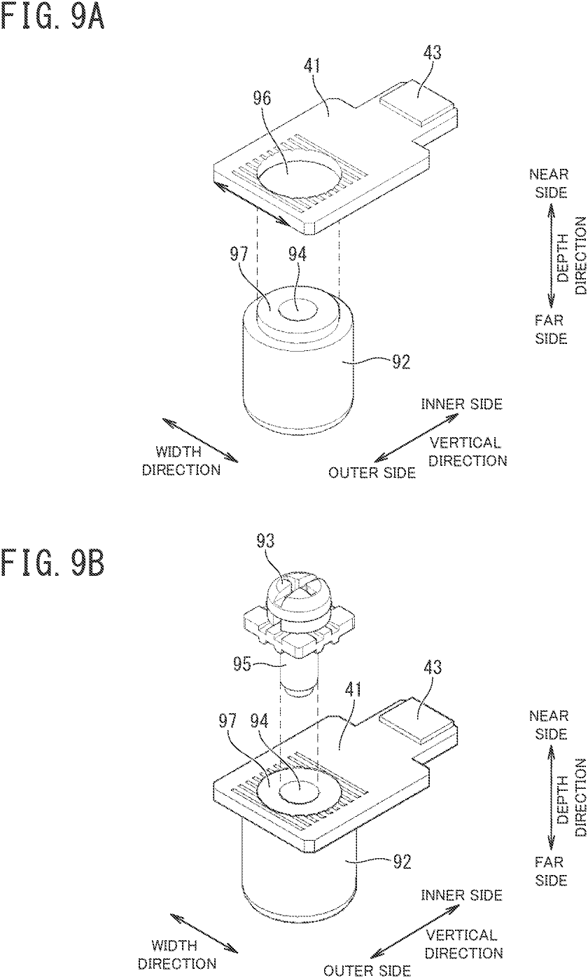

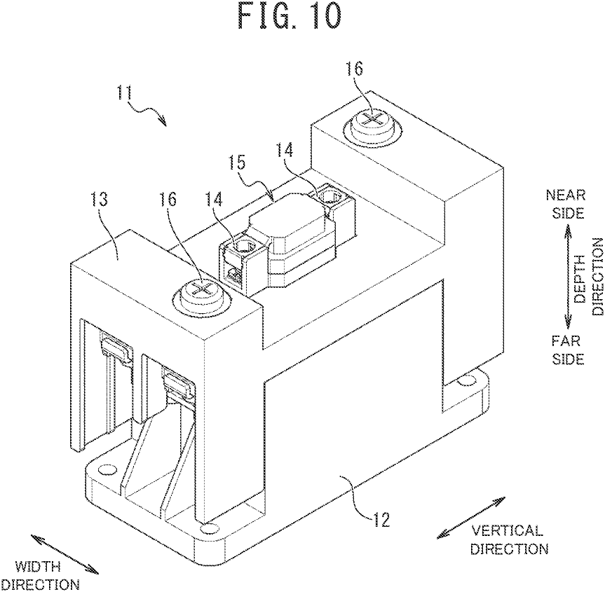

FIGS. 9A and 9B are diagrams illustrative of the nut member.

FIG. 9A illustrates fitting between a nut member 92 and an auxiliary fixed contact piece 41, and FIG. 9B illustrates fitting between the nut member 92 and a terminal screw 93. In the auxiliary fixed contact piece 41, a circular hole 96 (insertion hole), which has a larger diameter than the outer diameter of an external threaded portion 95 on the terminal screw 93, is formed on the other end side, which is located outside the small cylinder portion 27, and, on the nut member 92, a small-diameter portion 97, which fits into the circular hole 96, is formed on the near side in the depth direction. Height in the depth direction of the small-diameter portion 97 is the same as plate thickness of the auxiliary fixed contact piece 41. To the terminal screw 93, a square washer for wire holding and a spring washer are attached.

### Advantageous Effects

Next, main advantageous effects of the first embodiment will be described.

Although hermetically sealed containers, which house a main contact unit and an auxiliary contact unit, have been hitherto containers made of metal and covered by a lid made of ceramic, there has been a limit to miniaturization and weight reduction and a degree of freedom in design. Accordingly, in the present embodiment, the main contact unit 21, the auxiliary contact unit 22, and the electromagnet unit 23 are hermetically sealed in the hermetically sealed container 15, which is made of resin, and the hermetically sealed container 15 is filled with pressurized insulating gas. Using the hermetically sealed container 15 made of resin enables not only miniaturization and weight reduction to be achieved but also a degree of freedom in design to be improved. In addition, by arranging the main contact unit 21 and the auxiliary contact unit 22 in the hermetically sealed container 15 and causing the hermetically sealed container 15 to be filled with insulating gas, which improves breaking performance, it is possible to prevent an arc-extinguishing space from becoming larger in size.

To the hermetically sealed container 15, gas barrier coating is applied using laminated films of clay crystals. This configuration can suppress permeation of gas molecules, such as hydrogen and nitrogen, and thereby prevent leakage of pressurized insulating gas.

The main contact unit 21 includes the pair of main fixed contact pieces 31 and the main movable contact piece 32. The main fixed contact pieces 31 have the main fixed contacts 33 at one ends, and the other ends serve as main terminal portions to be connected to the main circuit. The main movable contact piece 32 has the pair of main movable contacts 34, which come into contact with and are separated from the main fixed contacts 33, and is supported by the contact support 51. The auxiliary contact unit 22 includes the pair of auxiliary fixed contact pieces 41 and the auxiliary movable contact piece 42. The pair of auxiliary fixed contact pieces 41 have the auxiliary fixed contacts 43 at one ends, and the other end sides serve as auxiliary terminal portions to be connected to the auxiliary circuit. The auxiliary movable contact piece 42 has the pair of auxiliary movable contacts 44, which come into contact with and are separated from the auxiliary fixed contacts 43, and is supported by the contact support 51. The electromagnet unit 23 switches opening/closing of the main contact unit 21 and opening/closing of the auxiliary contact unit 22 via the contact support 51. This configuration enables opening/closing of the main contact unit 21 and opening/closing of the auxiliary contact unit 22 to be easily switched.

The support springs 88 press the electromagnet unit 23 to the main contact unit 21 side with respect to the hermetically sealed container 15. Specifically, when the lid portion 25 is fixed to the container portion 24, the spool 61 is pressed to the pair of main fixed contact pieces 31 via the partition wall member 54 due to repulsive force of the support springs 88. This configuration can prevent backlash from occurring to the electromagnet unit 23 and the partition wall member 54 inside the hermetically sealed container 15. Two support springs 88 on one side and two support springs 88 on the other side in the vertical direction, that is, in total, four support springs 88 are disposed, and are arranged in such a way that repulsive force equally acts on both sides in the vertical direction of the spool 61. Because of this configuration, deviation of the center of gravity is reduced and stability is improved. In addition, workability when the hermetically sealed container 15 is assembled is also improved.

Each of coil contact pieces 81 has one end side arranged inside the hermetically sealed container 15, and the other end side of the coil contact piece 81 is connected to the control circuit outside the hermetically sealed container 15. The relay contact pieces 85 are fixed to the spool 61 of the electromagnet unit 23, and the coil 72 of the electromagnet unit 23 is connected to the relay contact pieces 85. The support springs 88 are made of metal and are arranged between the coil contact pieces 81 and the relay contact pieces 85 inside the hermetically sealed container 15. Because of this configuration, it is possible to maintain an excellent contact state between the coil contact pieces 81 and the relay contact pieces 85 by expansion and contraction of the support springs 88 even in an environment in which the electromagnetic contactor is vibrated, which enables reliability of the product to be improved.

The coil contact pieces 81 are subjected to surface treatment by chemical etching and are integrated with the hermetically sealed container 15 by insert molding. This processing causes the metal and the resin to be joined at the interface level and produces complex junctions exhibiting labyrinth effect, which enables gas molecules, such as hydrogen and nitrogen, to be prevented from leaking.

The pair of main fixed contact pieces 31 are formed in flat plate shapes and extend along a surface orthogonal to the direction in which the main contact unit 21 is opened and closed. Specifically, the pair of main fixed contact pieces 31 are arranged with a gap interposed between one end sides thereof inside the hermetically sealed container 15, the main fixed contact 33 is formed on one end side of each of the main fixed contact pieces 31, and the other end side of each of the main fixed contact pieces 31 is connected to the main circuit outside the hermetically sealed container 15. In addition, the main movable contact piece 32 has the main movable contacts 34 formed on both end sides and causes the main movable contacts 34 to respectively come into contact with and be separated from the main fixed contacts 33. The main contact unit 21 is formed by the main fixed contacts 33 and the main movable contacts 34. The pair of main fixed contact pieces 31 are subjected to surface treatment by chemical etching and are integrated with the hermetically sealed container 15 by insert molding. This processing causes the metal and the resin to be joined at the interface level and produces complex junctions exhibiting labyrinth effect, which enables gas molecules, such as hydrogen and nitrogen, to be prevented from leaking.

The pair of auxiliary fixed contact pieces 41 are arranged with a gap interposed between one end sides thereof inside the hermetically sealed container 15, the auxiliary fixed contact 43 is formed on one end side of each of the auxiliary fixed contact pieces 41, and the other end side of each of the auxiliary fixed contact pieces 41 is connected to the auxiliary circuit outside the hermetically sealed container 15. The auxiliary movable contact piece 42 has the auxiliary movable contacts 44 formed on both end sides and causes the auxiliary movable contacts 44 to respectively come into contact with and be separated from the auxiliary fixed contacts 43. The auxiliary contact unit 22 is formed by the auxiliary fixed contacts 43 and the auxiliary movable contacts 44. The pair of auxiliary fixed contact pieces 41 are subjected to surface treatment by chemical etching and are integrated with the hermetically sealed container 15 by insert molding. This processing causes the metal and the resin to be joined at the interface level and produces complex junctions exhibiting labyrinth effect, which enables gas molecules, such as hydrogen and nitrogen, to be prevented from leaking.

Each of the pair of auxiliary fixed contact pieces 41 is formed in a flat plate shape, and the circular hole 96, which has a larger diameter than the outer diameter of the external threaded portion 95 on the terminal screw 93, is formed on the other end side, which is located outside the hermetically sealed container 15. On the hermetically sealed container 15, the terminal receiving portions 91 are formed on the back surface side of the auxiliary fixed contact pieces 41, which are located outside the hermetically sealed container 15, and, on the terminal receiving portions 91, the nut members 92, which are made of metal, in each of which the bottomed threaded hole 94, into which the terminal screw 93 fits, is formed are disposed. Each of the nut members 92 is subjected to surface treatment by chemical etching and is integrated with the terminal receiving portion 91 by insert molding. This processing causes the metal and the resin to be joined at the interface level and produces complex junctions exhibiting labyrinth effect, which enables gas molecules, such as hydrogen and nitrogen, to be prevented from leaking.

When a configuration in which the nut member 92 is omitted, an internal threaded portion is formed in the circular hole 96 of the auxiliary fixed contact piece 41, and the terminal screw 93 is fitted into the internal threaded portion is employed, a threaded hole into which the external threaded portion 95 of the terminal screw 93 enters needs to be formed in the terminal receiving portion 91. This threaded hole has a larger diameter than the external threaded portion 95 of the terminal screw 93. Since it is required to apply gas barrier coating to the entire outer peripheral surface of the hermetically sealed container 15, gas barrier coating also needs to be applied to the inner peripheral surface of the threaded hole formed in the terminal receiving portion 91. However, since the auxiliary fixed contact piece 41 is disposed at the open end of the threaded hole, it is difficult to apply gas barrier coating to the inner peripheral surface of the threaded hole by spray method. Thus, by insert-molding the nut member 92 made of metal as described above, leakage of gas molecules, such as hydrogen and nitrogen, is prevented.

### Variations

Although, in the first embodiment, it is assumed that the auxiliary contact unit 22 is a b-contact of the normally-closed type, the present invention is not limited thereto, and the auxiliary contact unit 22 may be an a-contact of the normally-open type.

Although, in the first embodiment, gas barrier coating is applied only to the outer peripheral surface of the hermetically sealed container 15, the present invention is not limited thereto, and gas barrier coating may also be applied to the inner peripheral surface of the hermetically sealed container 15.

Although, in the first embodiment, the support springs 88 serve as both a support of the spool 61 and an electrical connection for the coil contact pieces 81, the present invention is not limited thereto. That is, the roles may be separated by disposing a spring member to support the spool 61 and a spring member to electrically connect the coil contact pieces 81.

### SECOND EMBODIMENT

### Configuration

The second embodiment is a hermetically sealed electromagnetic contactor 11 configured into a double pole type that includes two main contact units 21. That is, with the exception that the number of poles, that is, the number of main contact units 21, is increased, the second embodiment has the same configuration as that in the afore-described first embodiment, and the same reference signs are assigned to the same constituent components as those in the first embodiment and detailed description thereof will be omitted.

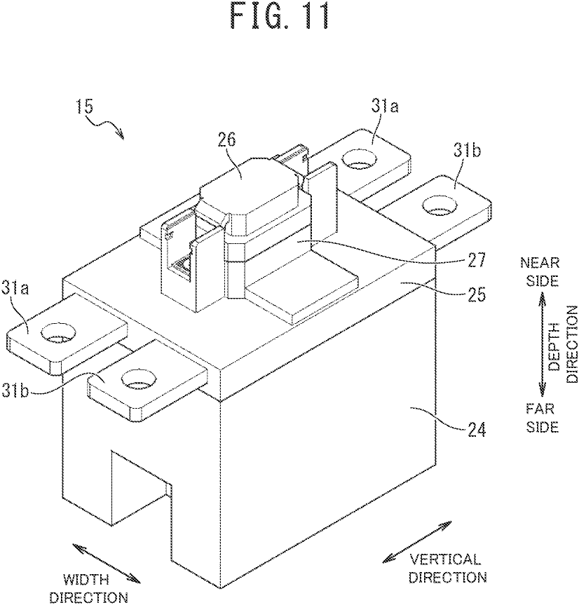

FIG. 10 is an external view of a hermetically sealed electromagnetic contactor (double poles).

A main terminal cover 13 is fixed by two resin nuts 16, and a resin nut 16 on a primary side portion of the main terminal cover 13 and the other resin nut 16 on a secondary side portion thereof are fixed to a main terminal of the first pole and a main terminal of the second pole, respectively.

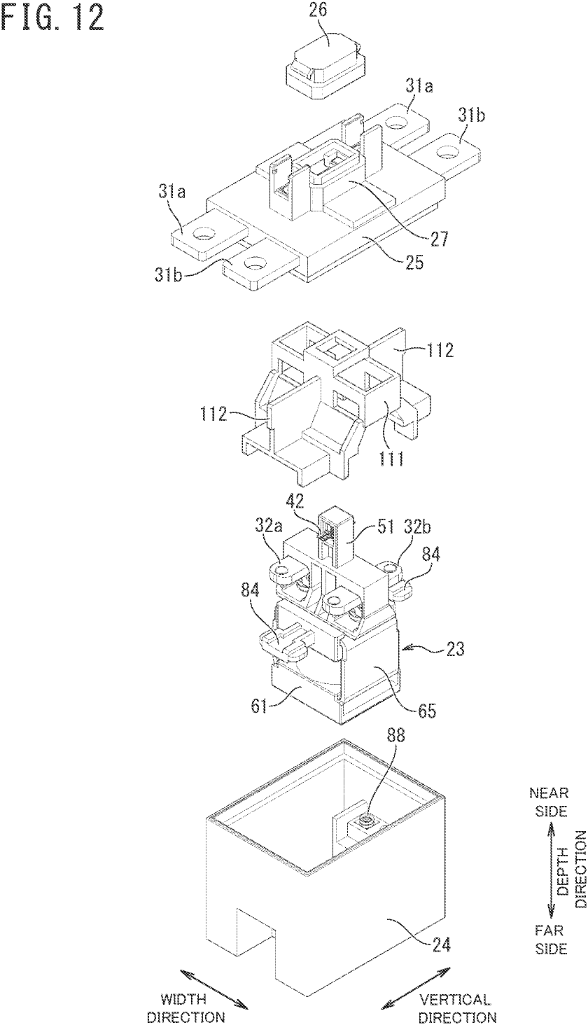

FIG. 11 is an external view of a hermetically sealed container (double poles).

In the following description, when the first pole and the second pole are distinguished from each other, “a” and “b” are appended to a reference sign related to the first pole and a reference sign related to the second pole, respectively. A pair of main fixed contact pieces 31a in the first pole and a pair of main fixed contact pieces 31b in the second pole are disposed on one side and the other side in the width direction, respectively.

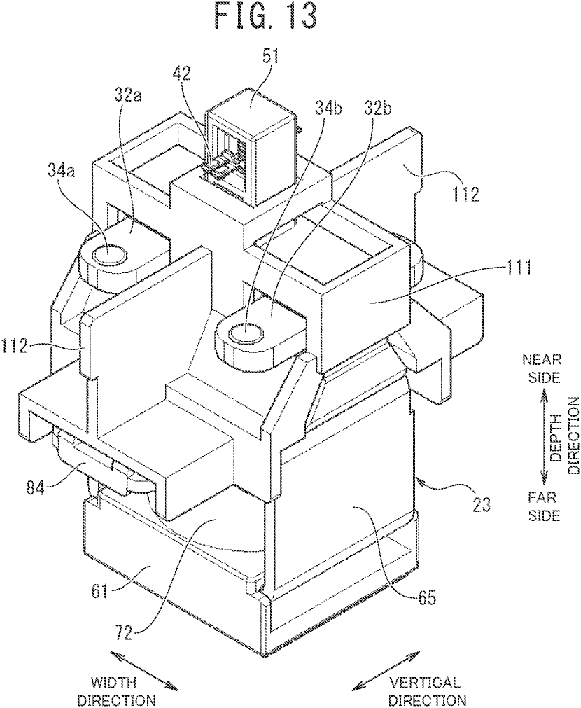

FIG. 12 is an exploded view of the hermetically sealed container (double poles).

A partition wall member 111 is made of a resin having electrical insulation and is housed on the near side in the depth direction in a container portion 24 while holding a contact support 51. On the partition wall member 111, on both sides in the vertical direction, inter-pole barriers 112 (partition wall members) that partition the first pole and the second pole, that is, the main contact units 21, from each other are formed.

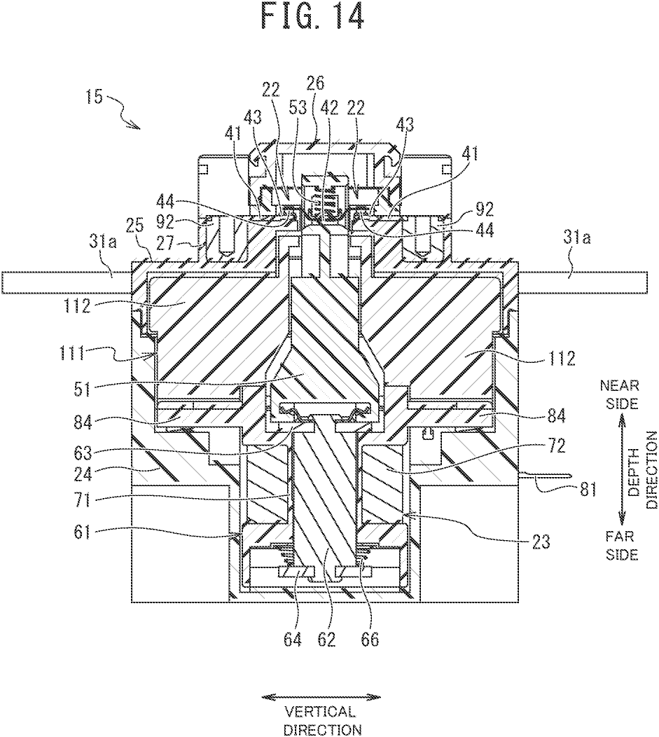

FIG. 13 is a diagram illustrative of the partition wall member, the contact support, and the electromagnet unit after assembly.

FIG. 14 is a cross-sectional view of the hermetically sealed container (double poles).

In this drawing, a cross section passing the center in the width direction and taken along the vertical direction and the depth direction is illustrated.

The inter-pole barriers 112 are made of a resin having electrical insulation, are formed in plate shapes aligned with the vertical direction and the depth direction, and are disposed at the center in the width direction. Inside a hermetically sealed container 15, the inter-pole barriers 112 partitioning the inside into a first pole side and a second pole side has improved electrical insulation between the respective poles in the main contact units 21.

### Advantageous Effects

Next, main advantageous effects of the second embodiment will be described.

In the second embodiment, the hermetically sealed electromagnetic contactor 11 is configured into the double pole type, and the inter-pole barriers 112 made of resin that partition the respective poles from each other are disposed on the partition wall member 111. This configuration can improve electrical insulation between the respective poles in the main contact units 21. Since hermetically sealed containers, which house main contact units, have been hitherto containers made of metal and covered by a lid made of ceramic, it has been difficult to secure electrical insulation between the respective poles inside a hermetically sealed container. In contrast, since use of the hermetically sealed container 15 made of resin enables the inter-pole barriers 112 to be easily formed even when the number of poles is multiple, it is possible to secure electrical insulation between the respective poles in the main contact units 21. Use of the hermetically sealed container 15 made of resin as described above enables a degree of freedom in design to be improved and a request for increase in the number of poles to be easily coped with.

### Variations

Although, in the second embodiment, the inter-pole barriers 112 are integrated with the partition wall member 111, the present invention is not limited thereto, and the inter-pole barriers 112 may be disposed as separate members or integrated with a lid portion 25.

Although, in the second embodiment, the hermetically sealed electromagnetic contactor 11 is configured into the double pole type, the present invention is not limited thereto, and the present embodiment is capable of adapting to a triple pole type or a quadruple pole type. Note, however, that the inter-pole barriers 112 are required to be disposed between respective poles for any pole type.

While the present invention has been described with reference to the limited number of embodiments, the scope of the rights of the invention is not limited thereto.

It will be obvious to those skilled in the art that various changes and modifications may be made in the embodiments based on the above disclosure.

### Reference Signs List

11 Hermetically sealed electromagnetic contactor
12 Case
13 Main terminal cover
14 Auxiliary terminal cover
15 Hermetically sealed container
16 Resin nut
21 Main contact unit
22 Auxiliary contact unit
23 Electromagnet unit
24 Container portion
25 Lid portion
26 Cap portion
27 Small cylinder portion
31 Main fixed contact piece
31a Main fixed contact piece
31b Main fixed contact piece
32 Main movable contact piece
33 Main fixed contact
34 Main movable contact
41 Auxiliary fixed contact piece
42 Auxiliary movable contact piece
43 Auxiliary fixed contact
44 Auxiliary movable contact
51 Contact support
52 Main contact spring
53 Auxiliary contact spring
54 Partition wall member
61 Spool
62 Plunger
63 Upper armature
64 Lower armature
65 Yoke
66 Return spring
71 Winding shaft
72 Coil
73 Side piece portion
74 Upper piece portion
75 Lower piece portion
81 Coil contact piece
82 Spool receiving portion
83 Deep recessed portion
84 Arm piece
85 Relay contact piece
86 Shallow recessed portion
87 Projecting portion
88 Support spring
91 Terminal receiving portion
92 Nut member
93 Terminal screw
94 Threaded hole
95 External threaded portion
96 Circular hole
97 Small-diameter portion
111 Partition wall member
112 Inter-pole barrier

1. A hermetically sealed electromagnetic contactor comprising:
a main contact unit including a pair of main fixed contact pieces, each of the main fixed contact pieces having a main fixed contact at one end and a terminal portion to be connected to a main circuit at the other end, and a main movable contact piece having a pair of main movable contacts configured to come into contact with and be separated from the main fixed contacts and configured to open and close an electrical path of the main circuit;
a contact support configured to support the main movable contact piece;
an electromagnet unit configured to switch opening/closing of the main contact unit via the contact support; and
a hermetically sealed container made of resin on an inside of which the main contact unit and the electromagnet unit are arranged, the hermetically sealed container having the inside filled with insulating gas.

2. The hermetically sealed electromagnetic contactor according to claim 1, wherein
a spring member is arranged in the hermetically sealed container, and
the spring member presses the electromagnet unit to the main contact unit side of the hermetically sealed container.

3. The hermetically sealed electromagnetic contactor according to claim 2 comprising:
a coil contact piece having one end side arranged inside the hermetically sealed container and the other end side connected to a control circuit outside the hermetically sealed container; and
a relay contact piece to which a coil of the electromagnet unit is connected, the relay contact piece being fixed to a spool of the electromagnet unit,
wherein the spring member is arranged between the coil contact piece and the relay contact piece.

4. The hermetically sealed electromagnetic contactor according to claim 3, wherein the coil contact piece is subjected to surface treatment by chemical etching and is integrated with the hermetically sealed container by insert molding.

5. The hermetically sealed electromagnetic contactor according to claim 1 comprising a plurality of the main contact units.

6. The hermetically sealed electromagnetic contactor according to claim 5, wherein the hermetically sealed container internally includes a partition wall member made of resin and configured to partition the main contact units from each other.

7. The hermetically sealed electromagnetic contactor according to claim 1, wherein the pair of main fixed contact pieces are formed in flat plate shapes and extend along a surface orthogonal to a direction in which the main contact unit is opened and closed.

8. The hermetically sealed electromagnetic contactor according to claim 1, wherein the main fixed contact pieces are subjected to surface treatment by chemical etching and are integrated with the hermetically sealed container by insert molding.

9. The hermetically sealed electromagnetic contactor according to claim 1 comprising:
a pair of auxiliary fixed contact pieces arranged with a gap interposed between one end sides inside the hermetically sealed container, each of the auxiliary fixed contact pieces having an auxiliary fixed contact formed on one end side and the other end side connected to an auxiliary circuit outside the hermetically sealed container; and
an auxiliary movable contact piece supported by the contact support, having auxiliary movable contacts formed on both end sides, and configured to cause the auxiliary movable contacts to respectively come into contact with and be separated from the auxiliary fixed contacts,
wherein the pair of auxiliary fixed contact pieces are subjected to surface treatment by chemical etching and are integrated with the hermetically sealed container by insert molding.

10. The hermetically sealed electromagnetic contactor according to claim 9, wherein
each of the pair of auxiliary fixed contact pieces is formed in a flat plate shape and, on the other end side located outside the hermetically sealed container, an insertion hole larger than outer diameter of an external threaded portion of a terminal screw to be connected to the auxiliary circuit is formed,
on the hermetically sealed container, terminal receiving portions are formed on a back surface side of the auxiliary fixed contact pieces located outside the hermetically sealed container,
in each of the terminal receiving portions, a nut member made of metal in which a bottomed threaded hole into which the terminal screw is fitted is formed is disposed, and
the nut members are subjected to surface treatment by chemical etching and are integrated with the terminal receiving portions by insert molding.

11. The hermetically sealed electromagnetic contactor according to claim 1, wherein, to the hermetically sealed container, gas barrier coating is applied using laminated films of clay crystals.
